(19) United States
(12) Patent Application Publication
(10) Pub. No.: US 2013/0222558 A1
(43) Pub. Date: Aug. 29, 2013

(54) PIXEL PROCESSOR AND PIXEL PROCESSING METHOD

(71) Applicants: Yutaka YAMADA, Tokyo (JP); Masayuki Tokunaga, Tokyo (JP); Tatsuo Saishu, Tokyo (JP)

(72) Inventors: Yutaka YAMADA, Tokyo (JP); Masayuki Tokunaga, Tokyo (JP); Tatsuo Saishu, Tokyo (JP)

(21) Appl. No.: 13/722,713

(22) Filed: Dec. 20, 2012

(30) Foreign Application Priority Data
Feb. 29, 2012 (JP) 2012-044420

(51) Int. Cl. H04N 13/04

(52) U.S. Cl. CPC H04N 13/04
USPC 348/59

(57) ABSTRACT

According to one embodiment, pixel processor includes: storage module; first adder; and second adder. Storage module stores initial parallax, initial coordinate, parallax difference, and coordinate difference. Initial parallax represents parallax of predetermined pixel. Initial coordinate represents coordinate of parallax image information of the predetermined pixel. Parallax difference is for calculating, from parallax of one pixel, parallax of other pixel. Coordinate difference is for calculating, from coordinate of parallax image information of one pixel, coordinate of parallax image information of other pixel. First adder adds the parallax difference to the initial parallax to calculate parallax of other pixel, and repeats adding the parallax difference to the calculated parallax to calculate parallax of each pixel. Second adder adds the coordinate difference to the initial coordinate to calculate coordinate of other pixel, and repeats adding the coordinate difference to the calculated coordinate to calculate coordinate of the parallax image information of each pixel.

### CROSS-REFERENCE TO RELATED APPLICATIONS

This application is based upon and claims the benefit of priority from Japanese Patent Application No. 2012-044420, filed on Feb. 29, 2012, the entire contents of which are incorporated herein by reference.

### FIELD

Embodiment described herein relate generally to a pixel processor and a pixel processing method.

### BACKGROUND

There have been proposed various techniques for achieving stereoscopic vision. For example, a parallax barrier method and a lenticular method achieve the stereoscopic vision by use of parallax of a user without wearing eyeglasses for attaining stereoscopic viewing.

In the parallax barrier method and the lenticular method, the stereoscopic vision for the user is achieved by rearranging and displaying pixels included in a plurality of parallax images having different parallaxes from each other. Several basic algorithms for rearranging the pixels have been proposed.

In the conventional technology, the algorithms often use division or remainder, and thus result in a large processing burden.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a configuration of a television receiver according to a first embodiment;

FIG. 2 is an exemplary diagram of a parallax image (8×6 pixels) displayed by the television receiver in the first embodiment;

FIG. 3 is an exemplary diagram of a display panel (16×12 pixels) provided in a display device in the first embodiment;

FIG. 4 is an exemplary diagram illustrating a principle of a lenticular method, in the first embodiment;

FIG. 5 is an exemplary diagram of the parallax image illustrated in FIG. 2 fitted onto the display device illustrated in FIG. 3, in the first embodiment;

FIG. 6 is an exemplary diagram of a display example of the parallax image after being corrected by a pixel converter in the first embodiment;

FIG. 7 is an exemplary diagram of parallaxes allocated to respective pixels arranged on the display device in the first embodiment;

FIG. 8 is an exemplary diagram of coordinates of parallax image data allocated to the respective pixels arranged on the display device in the first embodiment;

FIG. 9 is an exemplary diagram of a circuit configuration implemented using a conventional algorithm;

FIG. 10 is an exemplary diagram of a circuit configuration comprised in the pixel converter of a video processor in the first embodiment;

FIG. 11 is an exemplary block diagram of a configuration implemented by twelve parallel processes, in the first embodiment; and

FIG. 12 is an exemplary diagram of a circuit configuration comprised in a pixel converter of a video processor according to a modification of the first embodiment.

### DETAILED DESCRIPTION

In general, according to one embodiment, a pixel processor comprises: a storage module; a first adder; and a second adder. The storage module is configured to store therein an initial parallax value, an initial coordinate value, a parallax difference, and a coordinate difference. The initial parallax value represents a parallax allocated to a predetermined pixel comprised in a display area of a display which is capable of displaying a plurality of pieces of parallax image information with parallaxes different from each other. The initial coordinate value represents a coordinate of the parallax image information displayed in the predetermined pixel. The parallax difference is for calculating, from a parallax value representing a parallax allocated to one pixel, a parallax value allocated to other pixel. The coordinate difference is for calculating, from a coordinate of parallax image information displayed in one pixel, a coordinate of parallax image information displayed in other pixel. The first adder is configured to add the parallax difference to the initial parallax value to calculate a parallax value of other pixel different from the predetermined pixel, and thereafter to repeat adding the parallax difference to the calculated parallax value to calculate a parallax value allocated to each pixel. The second adder is configured to add the coordinate difference to the initial coordinate value to calculate a coordinate of other pixel different from the predetermined pixel, and thereafter to repeat adding the coordinate difference to the calculated coordinate to calculate a coordinate of the parallax image information allocated to each pixel.

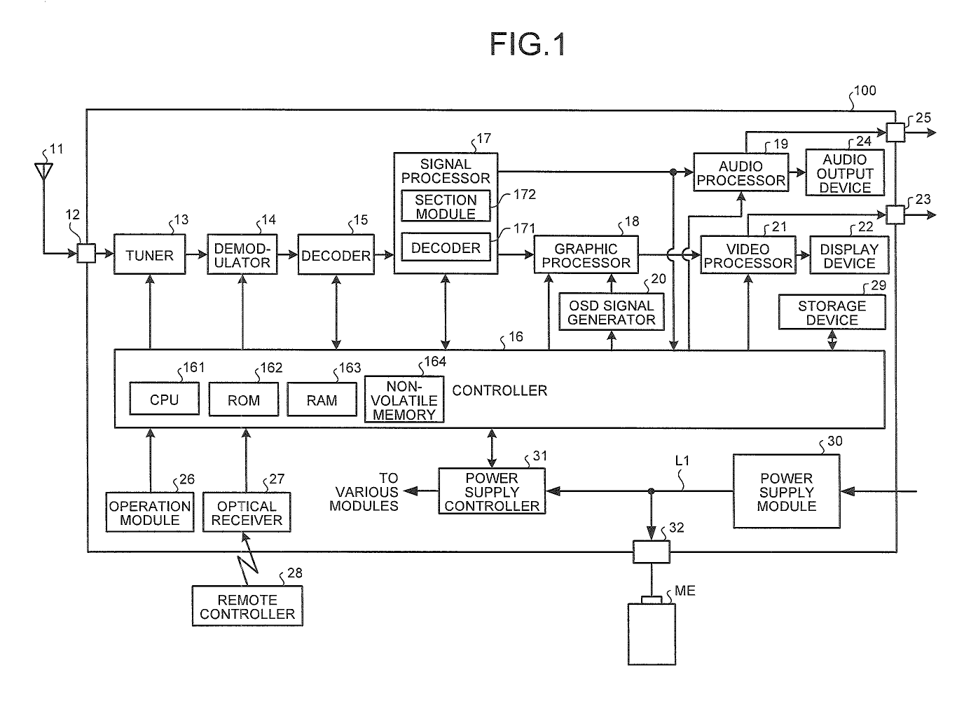

FIG. 1 is a diagram illustrating an example of a configuration of a television receiver 100 according to a first embodiment. As illustrated in FIG. 1, an antenna 11 for receiving broadcast waves is connected to an input side of the television receiver 100. A user of the television receiver 100 can operate the receiver through an operation module 26 provided on the television receiver 100 or through a remote controller 28.

The television receiver 100 displays a broadcast program by decoding received digital television broadcast signals, and thus enables the user to watch and listen to the broadcast program thus received. The television receiver 100 can also use a display device and an audio output device that are externally provided to enable watching and listening of the broadcast program, and can further record the received broadcast program.

Digital terrestrial television broadcast signals received by the antenna 11 for receiving broadcast waves are supplied to a tuner 13 for terrestrial digital broadcasting, through an input terminal 12.

Following the control of a controller 16, the tuner 13 selects a broadcast signal of a desired channel, and then outputs the selected broadcast signal to a demodulator 14. Following the control of the controller 16, the demodulator 14 demodulates the broadcast signal selected by the tuner 13 to obtain a transport stream including a desired program, and then outputs the transport stream to a decoder 15.

Following the control of the controller 16, the decoder 15 performs TS decoding processing of a transport stream (TS) multiplexed signal, and depacketizes digital video and audio signals of the desired program to obtain a packetized elementary stream (PES), and outputs the PES to an STD buffer (not illustrated) in a signal processor 17. The decoder 15 also outputs section information sent by the digital broadcast to a section module 172 of the signal processor 17. Here, the signal processor 17 comprises a decoder 171 and the section module 172, and processes the supplied input signals.

When the television is watched and listened to, the decoder 171 selectively applies predetermined digital signal processing to the digital video and audio signals supplied from the decoder 15, and outputs the processed signals to a graphic processor 18 and an audio processor 19. On the other hand, when the program is recorded, the decoder 171 stores (records) the signals obtained by selectively applying the predetermined digital signal processing to the digital video and audio signals supplied from the decoder 15, in a storage device 29 (such as an HDD) through the controller 16.

Moreover, when the recorded program is reproduced, the decoder 171 applies predetermined digital signal processing to data read out from the storage device 29 through the controller 16, and outputs the processed data to the graphic processor 18 and the audio processor 19.

Furthermore, when a display screen of an external device displays a picture, the decoder 171 applies predetermined digital signal processing to data received through the controller 16 from the external device connected to the television receiver 100, and outputs the processed data to the graphic processor 18 and the audio processor 19.

The controller 16 is supplied from the signal processor 17 with various types of data (such as key information for B-CAS descrambling) and electronic program guide (EPG) information for obtaining programs, program attribute information (such as program categories), and caption information, etc. (such as service information including SI and PSI). The controller 16 performs image generation processing for displaying the EPG and the caption based on these supplied information pieces, and outputs the generated image information to the graphic processor 18.

Furthermore, the controller 16 has a function to control recording programs and setting timer recording of programs. When the timer recording is to be set, the controller 16 displays the electronic program guide (EPG) information on a liquid crystal display comprised in a display device 22, and sets the content of the reservation in a predetermined storage module according to a user input through the operation module 26 or the remote controller 28. Then, the controller 16 controls the tuner 13, the demodulator 14, the decoder 15, and the signal processor 17 so as to record the reserved programs at preset time.

The section module 172 outputs, among the section information supplied from the decoder 15, the various types of data and the electronic program guide (EPG) information for obtaining the programs, the program attribute information (such as program categories), and the caption information, etc. (such as service information including SI and PSI).

The graphic processor 18 has a function to synthesize the digital video signal supplied from the decoder 171 in the signal processor 17, an on-screen display (OSD) signal generated in an OSD signal generator 20, image data provided by data broadcasting, and the EPG and the caption signals generated by the controller 16, and to output the synthesized signal to a video processor 21. In addition, when captions provided by closed-caption broadcasting is to be provided, the graphic processor 18 performs processing to superimpose caption information on the video signal, based on the caption information provided by the control from the controller 16. The digital video signal output from the graphic processor 18 is supplied to the video processor 21.

The video processor 21 converts the supplied digital video signal into an analog video signal that can be displayed on the display device 22 composed of the liquid crystal display and so on, and then, outputs the analog video signal to the display device 22 to display it as a video image on the display screen of the display device 22. The video processor 21 can also output a video signal having a format displayable on an external display device (not illustrated) to the external display device through an output terminal 23 so as to make the external display device display the video signal as a video image.

The video processor 21 also performs display processing using a plurality of pieces of supplied parallax image data. Moreover, the video processor 21 may, for example, generate a plurality of pieces of parallax image data from supplied image data. In addition, the video processor 21 comprises a pixel converter 1000 (to be described later).

The display device 22 displays a plurality of pieces of parallax image data. In other word, the display device 22 comprises a configuration that enables stereoscopic viewing to the user. The display device 22 according to the present embodiment enables stereoscopic viewing by using a lenticular method.

The audio processor 19 converts the supplied digital audio signal into an analog audio signal that can be reproduced by an audio output device 24. Then, the audio processor 19 outputs the analog audio signal to the audio output device 24, to reproduce the sound. The audio processor 19 can also output an audio signal having a format reproducible by an external audio output device (not illustrated) to the external audio output device through an output terminal 25, so as to make the external audio output device reproduce the audio signal as sound.

Here, the television receiver 100 controls the overall operation thereof including various receiving operations by using the controller 16. The controller 16 comprises a central processing unit (CPU) 161, a read-only memory (ROM) 162 storing therein programs executed by the CPU 161, a random access memory (RAM) 163 for providing a work area for the CPU 161, and a nonvolatile memory 164 storing therein various types of setting information, control information, and the like. The CPU 161 cooperates with various programs to control operation of various units in an integrated manner.

Specifically, the controller 16 receives operational information from the operation module 26, or receives operational information sent from the remote controller 28 through an optical receiver 27, and controls the respective units so as to reflect the content of the operational information (such as a channel switching operation).

The controller 16 also comprises a function to switch the state of the television receiver 100 between an operating state and a standby state according to a user input through the operation module 26 or the remote controller 28. Specifically, upon receipt of a power-on instruction, the controller 16 controls a power supply controller 31 (to be described later) so as to supply power to the respective modules (except to a power feed connector 32 to be described later) of the television receiver 100, and thereby, changes the state of the television receiver 100 into the operating state. On the other hand, upon receipt of a power-off instruction, the controller 16 controls the power supply controller 31 (to be described later) so as to reduce the amount of power supply to the respective modules of the television receiver 100, and thereby, changes the state of the television receiver 100 into the standby state in which power consumption is lower than that in the operating state. Here, in the standby state, power is continued to be supplied to portions necessary for changing the state of the television receiver 100 into the operating state, such as the optical receiver 27, a portion of the controller 16, and the power supply controller 31 (to be described later).

A power supply module 30 is supplied with AC power (commercial power) from outside through a plug-in connector for wiring or the like. The power supply module 30 applies processing such as rectification to the supplied AC power, and then supplies the processed power to the power supply controller 31 and the power feed connector 32 through a power supply line L1.

Following the control of the controller 16, the power supply controller 31 supplies power to the respective modules (except to the power feed connector 32) of the television receiver 100 while the television receiver 100 is operating (in the operating state). On the other hand, while the television receiver 100 is standing by (in the standby state), the power supply controller 31 continues to supply power to configurations, such as the optical receiver 27 and the controller 16, which require power during the standby state.

The power feed connector 32 supplies the power supplied from the power supply module 30 to mobile equipment ME connected in a detachable manner to the power feed connector 32, and thereby, for example, charges the connected mobile equipment ME. Although there is no particular limitation about the connector shape of the power feed connector 32, the shape is preferable to conform to a standard (such as the Universal Serial Bus (USB) or the IEEE 1394) generally used in portable information devices such as a cellular phone and in the mobile equipment ME such as a portable music player. In the present embodiment, description will be made of an example of using a connector shape called USB Type A Receptacle. The connection between the power feed connector 32 and the mobile equipment ME may be in the form of a connection through a connection cable or the like, or in the form of a direct connection.

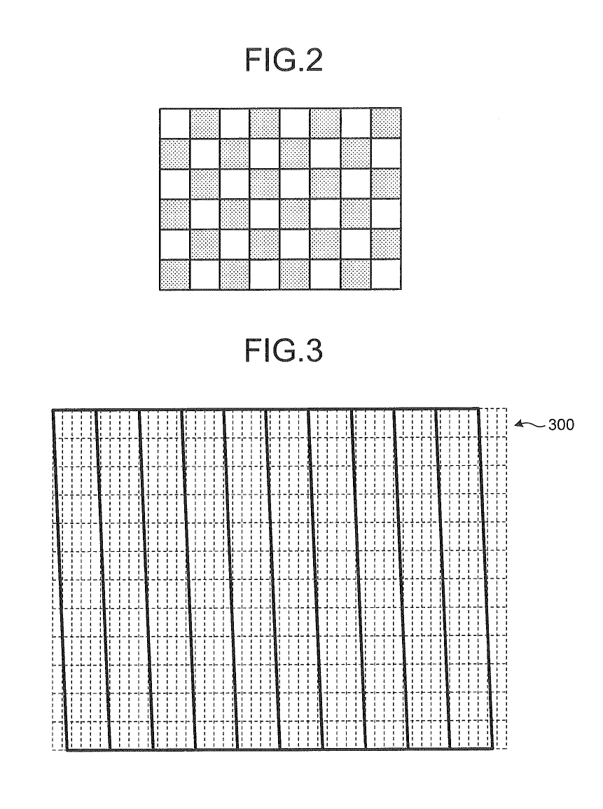

Description will be made of an aspect in which the television receiver 100 according to the present embodiment displays the parallax image data. FIG. 2 is a diagram illustrating an example of a parallax image (8×6 pixels) displayed by the television receiver 100. The number of pixels illustrated in FIG. 2 is chosen for convenience of explanation, and the checkered pattern is employed for convenience to distinguish boundaries between adjacent pixels. Note that the number of pixels and the display pattern illustrated in FIG. 2 are presented merely as an example, and do not provide any limitation on the image data to be displayed.

FIG. 3 is a diagram illustrating an example of a display panel provided in the display device 22. As illustrated in FIG. 3, a film is provided on a surface of a display panel 300 of the display device 22 according to the present embodiment. Further, lenticular lenses (camber-shaped lenses) are provided on the film. Each of the lenticular lenses is provided to the spacing divided by bold lines.

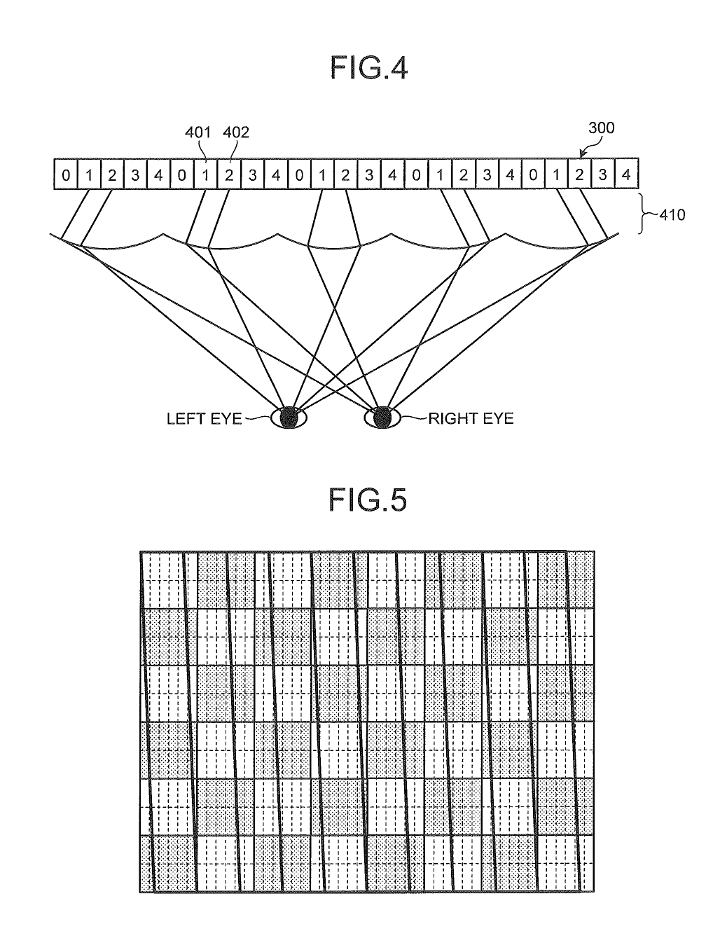

FIG. 4 is a diagram illustrating a principle of the lenticular method. As illustrated in FIG. 4, a lenticular sheet 410 serving as a light beam controlling element is provided on a front surface of the display panel 300 of the display device 22 on which the parallax image is displayed.

In the example illustrated in FIG. 4, the light emitted from the display device 22 is refracted by the lenticular sheet 410 to a plurality of different pointing directions, and advances.

In the example illustrated in FIG. 4, when an observer observes the display device 22 from a certain viewpoint, the observer perceives the light emitted from a plurality of subpixels numbered as 1 with one eye, and perceives the light emitted from a plurality of subpixels numbered as 2 with the other eye. For example, the right eye of the observer observes subpixels 401 numbered as 1, and the left eye of the observer observes subpixels 402 numbered as 2.

A group of subpixels numbered with the same number is a parallax image viewed from one parallax direction. That is, the group of subpixels numbered as 1 is a parallax image viewed from one parallax direction, while the group of the subpixels numbered as 2 is a parallax image viewed from another parallax direction. The observer perceives stereoscopically displayed image data by observing the different parallax images with the right and left eyes in this manner.

When the parallax image is displayed, the pixel converter included in the video processor 21 according to the present embodiment maps the parallax image on the display panel (16×12 pixels) of the display device 22 illustrated in FIG. 3. Note that the display panel illustrated in FIG. 3 is presented in units of the subpixels (R, G, and B). Although the present embodiment is described in the case of three colors of R, G, and B for each pixel, the number of colors for each pixel is not limited thereto. Three colors or more may be used for each pixel. For example, four colors of, for example, R, G, B, and Y may be used for each pixel.

When the pixel converter comprised in the video processor 21 allocates the parallax image to the subpixels on the display panel of the display device 22, the pixel converter enlarges the parallax image so as to be fitted to the panel size, and then allocates it. FIG. 5 illustrates an example in which the parallax image illustrated in FIG. 2 is fitted onto the display device 22 illustrated in FIG. 3. In the example illustrated in FIG. 5, the parallax image is doubled in the horizontal and vertical sizes thereof, and is fitted to the panel size.

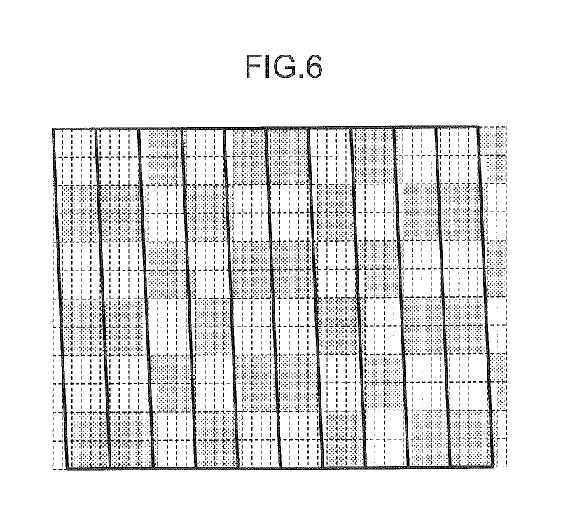

However, in practice, the same coordinate in the horizontal axis direction of the parallax image needs to be displayed on the same lenticular lens. For this reason, when the parallax image is displayed, the pixel converter corrects the parallax image so as to be displayed by width of the lenticular lens. FIG. 6 is a diagram illustrating a display example of the parallax image after being corrected by the pixel converter. It can be seen from the example illustrated in FIG. 6 that the respective colors of the checkered pattern are displayed by width of the lenticular lens.

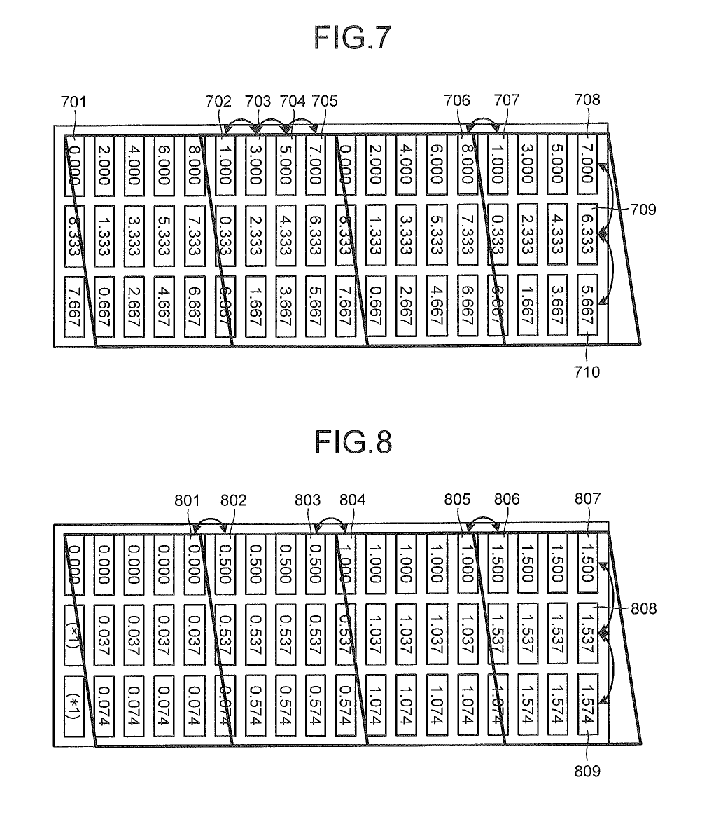

Next, description will be made of parallaxes allocated to the respective pixels arranged on the display device 22. FIG. 7 is a diagram illustrating the parallaxes allocated to the respective pixels arranged on the display device 22. The example illustrated in FIG. 7 is an example in which the number of parallaxes is nine. The parallax is 0 at the left end of the lens (such as at a pixel 701), and the parallax is 8 at the right end of the lens (such as at a pixel 706). Each of the pixels illustrated in FIG. 7 is the subpixel to which a color of red (R), green (G), or blue (B) is allocated.

As illustrated in FIG. 7, the parallax between subpixels adjacent in the horizontal direction is constant. For example, the parallax is 1.000 for a pixel 702, 3.000 for a pixel 703, 5.000 for a pixel 704, and 7.000 for a pixel 705. As illustrated by the parallaxes of these pixels, the parallax increases by 2.000 each time the pixel is shifted to the right by one pixel.

However, when the shift of pixel occurs between the lenses in the horizontal direction, a remainder is obtained from division using the number of parallaxes. For example, when the shift occurs by one pixel from the pixel 706 having a parallax of 8.000, the parallax increases by 2.000. However, a remainder (mod) is obtained by dividing 10.000 by the number of parallaxes 9 because the shift of pixel occurs between the lenses. By this calculation, the parallax of a pixel 707 is obtained to be 1.000.

The parallax between subpixels adjacent in the vertical direction is also constant. The parallax of each subpixel is allocated on the basis of an angle of the lenticular lens. Thus, for example, the parallax is 7.000 for a pixel 708, 6.333 for a pixel 709, and 5.667 for a pixel 710. As illustrated by the parallaxes of these pixels, the parallax decreases by 0.667 each time the pixel is shifted downward in the vertical direction by one pixel.

The parallax of each pixel is allocated in this manner. As illustrated in FIG. 7, each of the calculated parallax values may have decimal points. However, the pixel converter included in the video processor 21 truncates the decimal points when allocating an actual parallax to each of the pixels.

Next, description will be made of coordinates of the parallax image data allocated to the respective pixels arranged on the display device 22. FIG. 8 is a diagram illustrating the coordinates of the parallax image data allocated to the respective pixels arranged on the display device 22. In the example illustrated in FIG. 8, subpixels within a width of two lenticular lenses displays one pixel of the pieces of parallax image data. Therefore, the coordinate is increased by 0.5 each time the subpixel is shifted as from a pixel 801 to a pixel 802, from a pixel 803 to a pixel 804, and from a pixel 805 to a pixel 806. When an actual coordinate is allocated to each pixel, the pixel converter included in the video processor 21 truncates the decimal points of the coordinate. By this operation, the actual coordinate of a pixel to which a coordinate of 0.5 is allocated results to be 0.

The difference of coordinates between the subpixels adjacent in the vertical direction is also constant. For example, the coordinate is 1.500 for a pixel 807, 1.537 for a pixel 808, and 1.574 for a pixel 809. As illustrated by the differences between the coordinates of the pixels, the coordinate increases by 0.037 each time the pixel is shifted downward in the vertical direction by one pixel.

The pixel converter comprised in the video processor 21 needs to allocate the parallax and the coordinate to each of the pixels, based on the rules described above.

According to the rules described above, Equation (1) for calculating a value of the parallax P_{N} allocated to each of the subpixels is expressed as given below. Note that the variable N represents a position of each pixel in the x-axis direction of the subpixel. ΔP denotes parallax difference between the pixels. NP denotes the number of parallaxes.

P_{—}{N}=(P_{—}{N−1}+ΔP) mod (NP) (1)

In addition, according to the rules described above, Equation (2) for calculating the coordinate X_{N} of the parallax image data allocated to each of the subpixels is expressed as given below. Note that ΔX denotes a coordinate difference between coordinates of adjacent lenses, in other words, a value by which the coordinate increases when the coordinate is shifted between the lenses.

X_{—}{N}=X_{—}{N−1}+ROUNDDOWN((P_{—}{N−1}+ΔP)/(NP))*ΔX (2)

As for calculation of the parallax and the coordinate to be allocated to each of the pixels, there exists a document titled “C. V. Berkel, ‘Image preparation for 3D-LCD,’ Proc. SPIE, Stereoscopic Displays and Virtual Reality Systems, vol. 3639, pp. 84-91, 1999”.

In this document, the coordinate (k, l) and the parallax are expressed by following Equation (3). Note that n in the x-coordinate direction is expressed in units of subpixels, and l in the y-coordinate direction is expressed in units of pixels.

P_{—}{k, l}=((k+k_offset−3·1·tan α) mod Xn) *N_{—}tot/Xn (3)

In the example illustrated in Equation (3), k_offset denotes an offset of the lens when y=1. Xn denotes the width (in units of subpixels) in the x-direction (horizontal direction) of the lens. N_tot denotes the number of parallaxes. The number 3 indicated in Equation (3) represents the number of subpixels per pixel. Equation (3) can be transformed as follows.

$$\begin{matrix}P\_ \{ k , 1 \} = \{ ( k + k\_offset - 3 \cdot 1 \cdot tan α ) mod Xn \} * ( N\_tot / Xn ) \\ = \{ ( k + k\_offset - 3 \cdot 1 \cdot tan α ) * ( N\_tot / Xn ) \} mod N\_tot \\ = \{ ( k - 1 + k\_offset - 3 \cdot 1 \cdot tan α + 1 ) * ( N\_tot / Xn ) \} modN\_tot \\ = \{ \begin{matrix}( k - 1 + k\_offset - 3 \cdot 1 \cdot tan α ) * \\ ( N\_tot / Xn ) + ( N\_tot / Xn )\end{matrix} \} modN\_tot \\ = [ \begin{matrix}[ \{ \begin{matrix}( k - 1 + k\_offset - 3 \cdot 1 \cdot tan α ) * \\ ( N\_tot / Xn )\end{matrix} \} modN\_tot ] + \\ ( N\_tot / Xn )\end{matrix} ] modN\_tot \\ = ( P\_ \{ k , 1 \} + ( N\_tot / Xn ) ) modN\_tot ( 4 )\end{matrix} \qquad ( 3 )$$

Further, substituting an expression ΔP=N_tot/Xn into Equation (4) yields Equation (5), which can be seen to be equivalent to Equation (1).

P_{—}{k, l}=(P_{—}{k, l}+ΔP) mod N_{—}tot (5)

Next, the parallax will be described. When the parallax image is allocated to the display panel, the coordinate value of the parallax image to be referred to is constant between lenses if the width of each lens is constant. Hence, Equation (6) holds.

ΔX=Xn/3*(X_image/X_panel) (6)

Xn denotes the size (in units of subpixels) in the x-direction of the lens. X_image denotes the horizontal width of the parallax image. X_panel denotes the horizontal width of the panel.

When the coordinate is shifted without crossing over between the lenses, the relationship between the coordinate (N−1, L) and the coordinate (N, L) can be expressed by Equation (7) given below.

X_{—}{N, L}=X_{—}{N−1, L} (7)

When the coordinate is shifted between the lenses, the relationship between the coordinate (N−1, L) and the coordinate (N, L) can be expressed by following Equation (8).

X_{—}{N, L}=X_{—}{N−1, L}+ΔX (8)

The condition that the shift from the coordinate (N−1, L) to the coordinate (N, L) occurs between the lenses is given by a relation P_{N−1}−ΔP≧NP. Hence, Equation (7) and Equation (8) can be combined into Equation (9) given below. Thus, the resultant Equation (9) can be seen to be equivalent to Equation (2).

X_{—}{N, L}=X_{—}{N−1, L}+(ROUNDDOWN((P_{—}{N−1}+ΔP)/NP))*ΔX (9)

In this manner, an algorithm of panel mapping for realizing stereoscopic viewing without eyeglasses is represented by Equations (1) and (2). Accordingly, it is conceivable to apply a configuration for obtaining the parallax and the coordinate of each pixel by using Equations (1) and (2) to the pixel converter of the video processor 21.

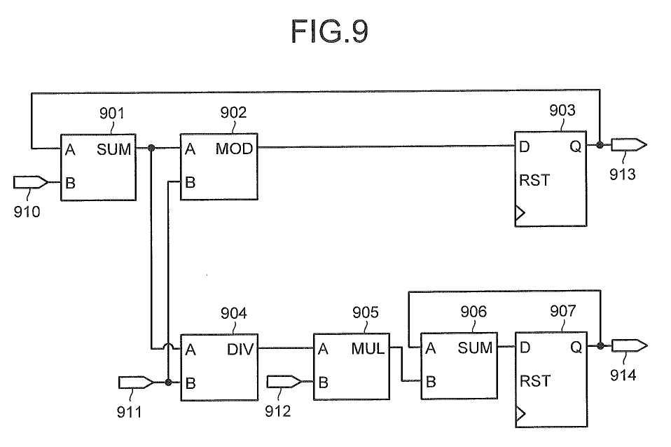

FIG. 9 is a diagram illustrating a circuit configuration implementing the processing represented by Equations (1) and (2) serving as a conventional algorithm. The circuit configuration illustrated in FIG. 9 comprises a first adder 901, a modulo calculator 902, a register 903, a divider 904, a multiplier 905, a second adder 906, and a register 907. The circuit configuration also comprises a first input port 910, a second input port 911, a third input port 912, a first output port 913, and a second output port 914.

A value of ΔP*S is entered from the first input port 910 to B of the first adder 901. A value of NP is entered from the second input port 911 to B of the modulo calculator 902 and B of the divider 904. A value of ΔX is entered from the third input port 912 to B of the multiplier 905.

The first output port 913 receives a value of the parallax P_{N} from the register 903, and outputs the received value. The second output port 914 receives a value of the coordinate X_{N} from the register 907, and outputs the received value.

The circuit illustrated in FIG. 9 comprises the multiplier, the divider, and the modulo calculator, and thus, result in a large processing load.

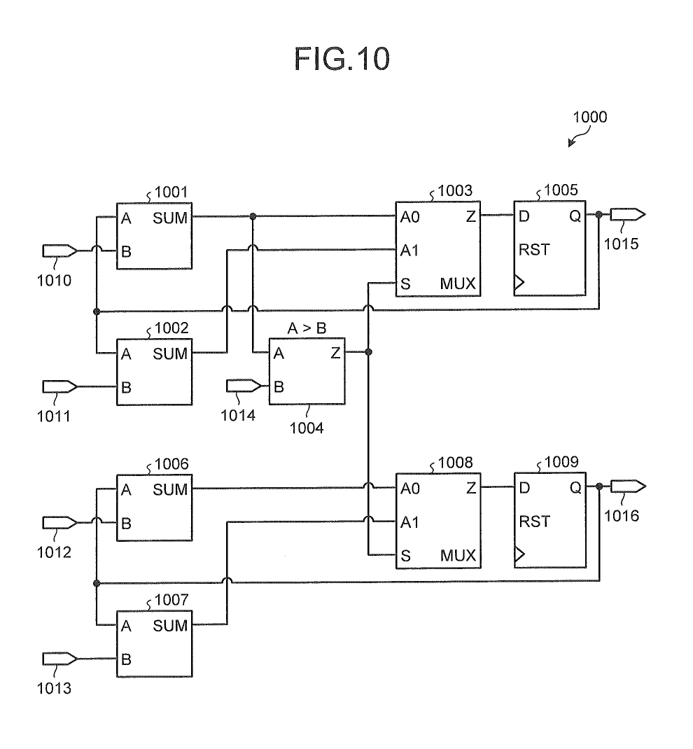

Therefore, the pixel converter 1000 of the video processor 21 according to the present embodiment is implemented in a configuration illustrated below. FIG. 10 is a diagram illustrating a circuit configuration comprised in the pixel converter 1000 of the video processor 22 according to the present embodiment.

As illustrated in FIG. 10, the pixel converter 1000 is configured to comprise a first adder 1001, a second adder 1002, a third adder 1006, a fourth adder 1007, a comparator 1004, a first selector 1003, a second selector 1008, a first register 1005, and a second register 1009. The pixel converter 1000 further comprises a first input port 1010, a second input port 1011, a third input port 1012, a fourth input port 1013, a fifth input port 1014, a first output port 1015, and a second output port 1016.

The pixel converter 1000 according to the present embodiment comprises the configuration illustrated in FIG. 10, and thus can reduce the processing burden thereof compared with the circuit configuration illustrated in FIG. 9. Next, description will be made of calculation formulae serving as a basis for implementing the circuit configuration illustrated in FIG. 10.

In addition, in the present embodiment, a plurality of pixels are processed in parallel because sequentially processing one pixel by one pixel requires long time.

In the case of processing the algorithm based on Equations (1) and (2) in parallel, what is required for calculating the parallax and the coordinate of a subpixel is not the parallax or the coordinate of the previous subpixel but the parallax and the coordinate of a subpixel before the previous subpixel. For example, in case of processing S subpixels in parallel, Equations (1) and (2) are changed to following Equations (10) and (11), respectively.

P_{—}{N}=(P_{—}{N−S}+ΔP*S) mod (NP) (10)

X_{—}{N}=X_{—}{N−S}+ROUNDDOWN((P_{—}{N−S}+ΔP*S)/(NP))*ΔX (11)

Depending on whether the value of P_{N−S}+((ΔP*S) mod NP) is greater than or equal to NP, Equation (10) can be expressed as one of two equations given below. That is, if (P_{N−S}⇄((ΔP*S) mod NP)<NP), in other words, if a shift from P_{N−S} to P_{N} occurs without crossing over between the lenses, the value of the parallax P_{N} is calculated using Equation (12).

P_{—}{N}=P_{—}{N−S}+((ΔP*S) mod NP) (12)

Furthermore, if (P_{N−S}+(ΔP*S) mod NP)≧NP), in other words, if the shift from P_{N−S} to P_{N} occurs over between the lenses, the value of the parallax P_{N} is calculated using Equation (13).

P_{—}{N}=(P_{—}{N−S}+((ΔP*S) mod NP)−NP (13)

In addition, depending on whether the value of P_{N−S}+((ΔP*S) mod NP) is greater than or equal to NP, Equation (11) can be expressed as one of two equations given below. That is, if (P_{N−S}+((ΔP*S) mod NP)<NP), the coordinate X_{N} is calculated using Equation (14).

X_{—}{N}=X_{—}{N−S}+ROUNDDOWN((ΔP*S)/(NP))*ΔX (14)

Furthermore, if (P_{N−S}+(ΔP*S) mod NP)≧NP), the coordinate X_{N} is calculated using Equation (15).

X_{—}{N}=X_{—}{N−S}+(ROUNDDOWN((ΔP*S)/(NP))+1) (15)

In order to implement Equations (12), (13), (14), and (15) described above as a circuit, each set of invariable parameters are combined as a fixed parameter.

For example, the combinations are formed as follows: ΔP0=((ΔP*S) mod NP); ΔP1=((ΔP*S) mod NP)−NP; ΔX0=ROUNDDOWN((ΔP*S)/(NP))*ΔX; and ΔX1=ROUNDDOWN((ΔP*S)/(NP))+1)*ΔX. As a result, the equations for calculating the parallaxes can be expressed as follows: Equation (12) as Equation (16), and Equation (13) as Equation (17).

P_{—}{N}=P_{—}{N−S}+ΔP0 (16)

where (P_{N−S}+ΔP0<NP)

P_{—}{N}=P_{—}{N−S}−ΔP1 (17)

where (P_{N−S}+ΔP0≧NP)

In addition, the equations for calculating the coordinates can be expressed as follows: Equation (14) as Equation (18), and Equation (15) as Equation (19).

X_{—}{N}=X_{—}{N−S}+ΔX0 (18)

where (X_{N−S}+ΔX0<NP)

X_{—}{N}=X_{—}{N−S}−ΔX1 (19)

where (X_{N−S}+ΔX0≧NP)

A circuit configuration implementing the processing represented by Equations (16) to (19) serves as the circuit configuration according to the present embodiment illustrated in FIG. 10. Compared with the circuit configuration illustrated in FIG. 9, the circuit configuration illustrated in FIG. 10 is implemented by a simple circuit free from a multiplier, a divider, and a modulo calculator.

The circuit implementing the processing represented by Equations (16) to (19) behaves according to recurrence equations. Therefore, initial values need to be entered at the start of the processing. The initial values are P_0 and X_0. P_0 and X_0 are the parallax and the coordinate, respectively, of a subpixel, for example, at the left end of a line from which the processing is started, on the display panel of the display device 22. The parallax and the coordinate of the subpixel at the left end need to be externally obtained.

The ROM 162 according to the present embodiment stores therein the parallax and the coordinate of the subpixel at the left end serving as an initial value of the parallax and an initial value of the coordinate, respectively. Then, when the parallax and the coordinate of each pixel are to be calculated, the pixel converter 1000 obtains the parallax and the coordinate of the subpixel at the left end, from the ROM 162. However, the initial values are not limited to be obtained from the ROM 162, and for example, values calculated in the controller 16 may be obtained.

The ROM 162 further stores therein ΔP0, ΔP1, ΔX0, and ΔX1. Each of ΔP0 and ΔP1 is a difference in parallax for calculating, from a parallax allocated to one pixel, a parallax allocated to another pixel. Each of ΔX0 and ΔX1 is a difference in coordinate for calculating, from a coordinate of parallax image data displayed in one pixel, a coordinate of parallax image data displayed in the other pixel.

A value of ΔP0 is entered from the first input port 1010 to B of the first adder 1001. A value of ΔP1 is entered from the second input port 1011 to B of the second adder 1002. A value of ΔX0 is entered from the third input port 1012 to B of the third adder 1006. A value of ΔX1 is entered from the fourth input port 1013 to B of the fourth adder 1007. A value of NP is entered from the fifth input port 1014 to B of the comparator 1004.

The first output port 1015 receives a value of the parallax P_{N} from the first register 1005, and outputs the received value. The second output port 1016 receives a value of the coordinate X_{N} from the second register 1009, and outputs the received value.

The first adder 1001 is supplied through A with the initial value of the parallax at the start of the processing, and then from the next time on, supplied with a value of a parallax stored in the first register 1005. The first adder 1001 is supplied with the value of ΔP0 through B. Then, the first adder 1001 adds the parallax difference ΔP0 to the initial value of the parallax to calculate a parallax of a pixel (other than the initial pixel) that is shifted from the initial pixel by the number of parallel processes S. Thereafter, the first adder 1001 repeats adding the parallax difference ΔP0 to the parallax held in the first register 1005.

The second adder 1002 is supplied through A with the initial value of the parallax at the start of the processing, and then from the next time on, supplied with the value of the parallax stored in the first register 1005. The second adder 1002 is supplied with the value of ΔP1 through B. Then, the second adder 1002 adds the parallax difference ΔP1 to the initial value of the parallax to calculate a parallax of a pixel (other than the initial pixel) that is shifted from the initial pixel by the number of parallel processes S. Thereafter, the second adder 1002 repeats adding the parallax difference ΔP1 to the parallax held in the first register 1005.

Based on a result of comparison by the comparator 1004, it is determined which of the parallax value calculated in the first adder 1001 and the parallax value calculated in the second adder 1002 is to be used.

The comparator 1004 is supplied through A with a result of calculation by the first adder 1001. The comparator 1004 is supplied with the number of parallaxes NP through B. Then, the comparator 1004 determines whether the result of calculation by the first adder 1001, that is, a value obtained by adding the parallax difference ΔP0 to the previous parallax stored in the first register 1005, is greater than or equal to the number of parallaxes NP. Then, the comparator 1004 outputs the result of determination to the first selector 1003 and the second selector 1008.

If the value obtained by adding the parallax difference ΔP0 to the previous parallax is determined by the comparator 1004 to be greater than or equal to the number of parallaxes NP, the first selector 1003 selects and outputs the result of addition by the second adder 1002. On the other hand, if the value obtained by adding the parallax difference ΔP0 to the previous parallax is determined by the comparator 1004 to be less than the number of parallaxes NP, the first selector 1003 selects and outputs the result of addition by the first adder 1001.

The first register 1005 stores therein and externally outputs the result of addition that is output from the first selector 1003, and also outputs the result of addition to the first adder 1001 and the second adder 1002 in order to calculate the next parallax.

Next, a configuration for calculating the coordinate will be described. The result of comparison by the comparator 1004 is also used for calculating the coordinate.

The third adder 1006 is supplied through A with the initial value of the coordinate at the start of the processing, and then from the next time on, supplied with a coordinate stored in the second register 1009. The third adder 1006 is supplied with ΔX0 through B. Then, the third adder 1006 adds the coordinate difference ΔX0 to the initial value of the coordinate to calculate a coordinate of a pixel that is shifted from the initial pixel by the number of parallel processes S. Thereafter, the third adder 1006 repeats adding the coordinate difference ΔX0 to the coordinate held in the second register 1009.

The fourth adder 1007 is supplied through A with the initial value of the coordinate at the start of the processing, and then from the next time on, supplied with a coordinate stored in the second register 1009. The fourth adder 1007 is supplied with ΔX1 through B. Then, the fourth adder 1007 adds the coordinate difference ΔX1 to the initial value of the coordinate to calculate a coordinate of a pixel that is shifted from the initial pixel by the number of parallel processes S. Thereafter, the fourth adder 1007 repeats adding the coordinate difference ΔX1 to the coordinate held in the second register 1009.

If the value obtained by adding the parallax difference ΔP0 to the previous parallax is determined by the comparator 1004 to be greater than or equal to the number of parallaxes NP, the second selector 1008 selects and outputs the result of addition by the fourth adder 1007. On the other hand, if the value obtained by adding the parallax difference ΔP0 to the previous parallax is determined by the comparator 1004 to be less than the number of parallaxes NP, the second selector 1008 selects and outputs the result of addition by the third adder 1006.

The second register 1009 stores therein and externally outputs the result of addition that is output from the second selector 1008, and also outputs the result of addition to the third adder 1006 and the fourth adder 1007 in order to calculate the next coordinate.

The example illustrated in FIG. 10 is a diagram presented so as to facilitate understanding of actually executed calculation. Actually performing the parallel processing requires initial values for the number of parallel processes and arithmetic circuits for the number of parallel processes. For example, if the number of parallel processes S is 12, initial values for 12 subpixels are required. If one pixel has three subpixels, for example, parallaxes and coordinates for four pixels at the left end are required. That is, if the number of parallel processes S is 12, the ROM 162 stores therein parallaxes and coordinates for four pixels at the left end.

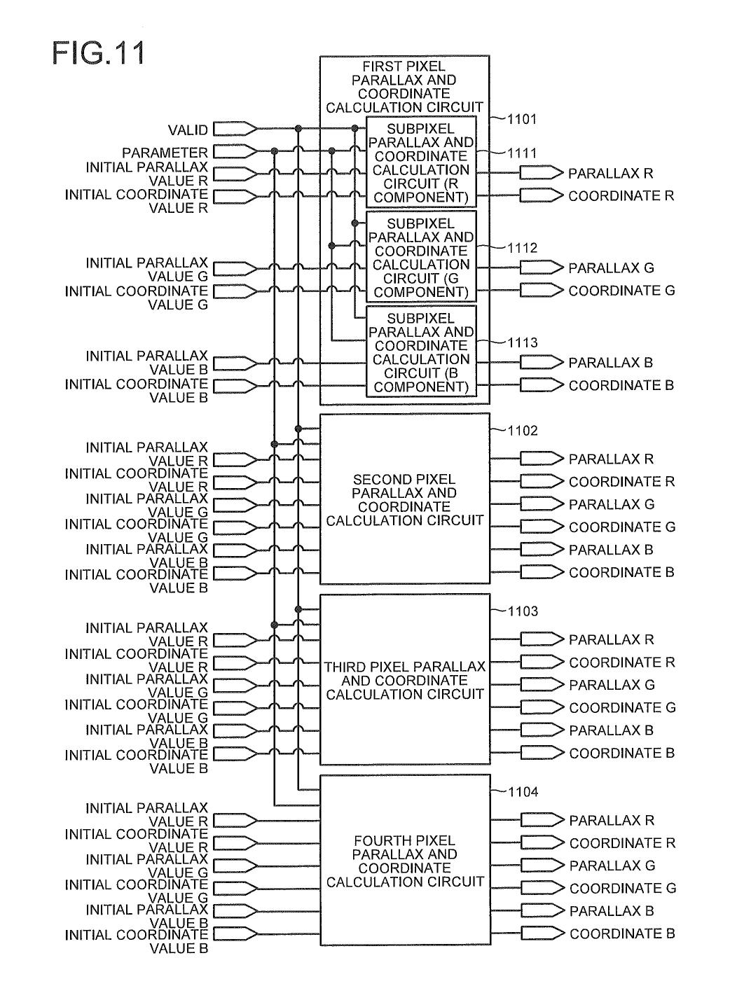

FIG. 11 is a block diagram illustrating a configuration implemented by providing 12 of such circuits illustrated in FIG. 10 in parallel. In the example illustrated in FIG. 11, the pixel converter 1000 comprises a first pixel parallax and coordinate calculation circuit 1101, a second pixel parallax and coordinate calculation circuit 1102, a third pixel parallax and coordinate calculation circuit 1103, and a fourth pixel parallax and coordinate calculation circuit 1104.

Each of the first pixel parallax and coordinate calculation circuit 1101, the second pixel parallax and coordinate calculation circuit 1102, the third pixel parallax and coordinate calculation circuit 1103, and the fourth pixel parallax and coordinate calculation circuit 1104 calculates a parallax and a coordinate of each of the three subpixels comprised in one pixel.

The first pixel parallax and coordinate calculation circuit 1101 comprises a subpixel parallax and coordinate calculation circuit (R component) 1111, a subpixel parallax and coordinate calculation circuit (G component) 1112, and a subpixel parallax and coordinate calculation circuit (B component) 1113.

Each of the subpixel parallax and coordinate calculation circuit (R component) 1111, the subpixel parallax and coordinate calculation circuit (G component) 1112, and the subpixel parallax and coordinate calculation circuit (B component) 1113 comprises the circuit configuration illustrated in FIG. 10. That is, the first pixel parallax and coordinate calculation circuit 1101 performs parallel processing for three subpixels.

The second pixel parallax and coordinate calculation circuit 1102, the third pixel parallax and coordinate calculation circuit 1103, and the fourth pixel parallax and coordinate calculation circuit 1104 each comprises the same configuration as that of the first pixel parallax and coordinate calculation circuit 1101, and thus, the explanations thereof are omitted.

The first pixel parallax and coordinate calculation circuit 1101, the second pixel parallax and coordinate calculation circuit 1102, the third pixel parallax and coordinate calculation circuit 1103, and the fourth pixel parallax and coordinate calculation circuit 1104 perform parallel processing for 12 subpixels.

In the example illustrated in FIG. 11, the respective circuits are supplied with initial values of respective pixels different from each other. For example, the first pixel parallax and coordinate calculation circuit 1101 is supplied with initial values of a pixel at the left end; the second pixel parallax and coordinate calculation circuit 1102 is supplied with initial values of a second pixel from the left; the third pixel parallax and coordinate calculation circuit 1103 is supplied with initial values of a third pixel from the left; and the fourth pixel parallax and coordinate calculation circuit 1104 is supplied with initial values of the fourth pixel from the left.

Note that all of the pixel parallax and coordinate calculation circuits are each supplied with the same parameters ΔP0, ΔP1, ΔX0, ΔX1, and NP because the parameters ΔP0, ΔP1, ΔX0, ΔX1, and NP are common for all of the circuits.

In the present embodiment, the pixel converter comprises the configuration described above, and thus can perform in parallel the calculation processing of obtaining the parallax and the coordinate of each of the 12 subpixels included in the four pixels.

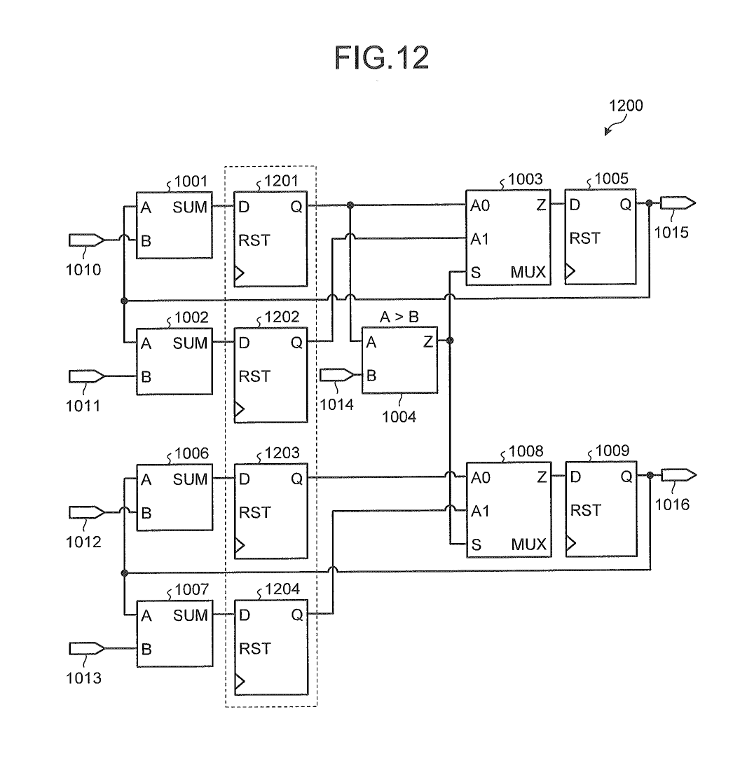

The circuit configuration is not limited to that of the first embodiment illustrated in FIG. 10. FIG. 12 is a diagram illustrating a circuit configuration included in a pixel converter 1200 of the video processor 21 according to a modification of the first embodiment.

Compared with the configuration of the pixel converter 1000 of the first embodiment, the configuration of the pixel converter 1200 illustrated in FIG. 12 additionally comprises registers 1201 to 1204 that store therein results obtained by calculation in the respective adders.

As illustrated in FIG. 12, the register 1201 is added between the adder 1001 and the selector 1003 or the comparator 1004. Further, the register 1202 is added between the adder 1002 and the selector 1003. Further, the register 1203 is added between the adder 1006 and the selector 1008. Further, the register 1204 is added between the adder 1007 and the selector 1008. Thus, the results of calculation by the adders 1001, 1002, 1006, and 1007 can be immediately supplied to the selectors 1003 and 1008, and therefore, delays in the circuits can be smaller than those in the first embodiment. As a result, a high-speed operation is enabled.

However, in the modification, two cycles are required until the results of calculation are output because the configuration illustrated in FIG. 12 is provided. Therefore, parameters for twice the number of parallel processes are further required, compared with the first embodiment.

In the configuration illustrated in FIG. 12, S is 24 when 12 subpixels are processed in parallel.

In addition, as initial values to be supplied to each one of the subpixel parallax and coordinate calculation circuits, a parallax and a coordinate of an i-th pixel (0≦i<12) from the left end, and a parallax and a coordinate of an (i+12)-th pixel from the left end are required.

The present embodiment and the modification thereof use the adders, the comparator, and the selectors to implement the same processing as that implemented by using the modulo calculator, the multiplier, and the divider according to the conventional algorithm. Therefore, the processing burden can be reduced.

In addition, the embodiment and the modification thereof described above realize the parallel calculation processing of parallaxes and coordinates of a plurality of pixels. The circuit configurations described above take periodicity of input parameters into consideration, thereby enabling low power consumption and downsizing (reduction in area).

The embodiment and the modification thereof described above can also improve a clock, instead of saving power consumption, so as to achieve higher speed.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pixel processor comprising:
a storage module configured to store therein an initial parallax value, an initial coordinate value, a parallax difference, and a coordinate difference, wherein
the initial parallax value represents a parallax allocated to a predetermined pixel comprised in a display area of a display which is capable of displaying a plurality of pieces of parallax image information with parallaxes different from each other,
the initial coordinate value represents a coordinate of the parallax image information displayed in the predetermined pixel,
the parallax difference is for calculating, from a parallax value representing a parallax allocated to one pixel, a parallax value allocated to other pixel, and
the coordinate difference is for calculating, from a coordinate of parallax image information displayed in one pixel, a coordinate of parallax image information displayed in other pixel;
a first adder configured to add the parallax difference to the initial parallax value to calculate a parallax value of other pixel different from the predetermined pixel, and thereafter to repeat adding the parallax difference to the calculated parallax value to calculate a parallax value allocated to each pixel; and
a second adder configured to add the coordinate difference to the initial coordinate value to calculate a coordinate of other pixel different from the predetermined pixel, and thereafter to repeat adding the coordinate difference to the calculated coordinate to calculate a coordinate of the parallax image information allocated to each pixel.

2. The pixel processor of claim 1,
wherein the storage module is configured to store therein:
each initial parallax value for a predetermined number of pixels;
each initial coordinate value for the predetermined number of pixels;
a parallax difference for calculating, from a parallax value representing a parallax allocated to one pixel, a parallax value representing a parallax allocated to other pixel shifted from the one pixel by the predetermined number of pixels; and
a coordinate difference for calculating, from a coordinate of parallax image information displayed in one pixel, a coordinate of parallax image information displayed in other pixel shifted from the one pixel by the predetermined number of pixels,
wherein the first adder is configured to perform in parallel the same number of processes as the predetermined number of pixels, each of the processes adding the parallax difference to the parallax value of the predetermined pixel to calculate a parallax value of a pixel shifted from the predetermined pixel by the predetermined number of pixels,
wherein the second adder is configured to perform in parallel the same number of processes as the predetermined number of pixels, each of the processes adding the coordinate difference to the coordinate of the predetermined pixel to calculate a coordinate of a pixel shifted from the predetermined pixel by the predetermined number of pixels, and
wherein the predetermined pixels of the parallel processes differ from each other in the first adder and the second adder.

3. The pixel processor of claim 2,
wherein the memory is configured to store therein, as the parallax difference, a first parallax difference and a second parallax difference different from the first parallax difference, and to store therein, as the coordinate difference, a first coordinate difference and a second coordinate difference different from the first coordinate difference,
wherein the first adder is configured to add the first parallax difference to the parallax value, and to add the second parallax difference to the parallax value,
wherein the second adder is configured to add the first coordinate difference to the coordinate, and to add the second coordinate difference to the coordinate,
wherein the pixel processor further comprises:
a determination module configured to determine whether a value obtained by adding the first parallax difference to the parallax value by the first adder is equal to or more than a number of parallaxes displayable on the display;
a first selector configured to select, if the determination module determines that the value is equal to or more than the number of parallaxes, the result obtained by adding the second parallax difference to the parallax value as a result of a plurality of additions performed by the first adder, and to select, if the determination module determines that the value is less than the number of parallaxes, the result obtained by adding the first parallax difference to the parallax value as a result of the additions performed by the first adder; and
a second selector configured to select, if the determination module determines that the value is equal to or more than the number of parallaxes, the result obtained by adding the second coordinate difference to the coordinate as a result of a plurality of additions performed by the second adder, and to select, if the determination module determines that the value is less than the number of parallaxes, the result obtained by adding the first coordinate difference to the coordinate as a result of the additions performed by the second adder.

4. The pixel processor of claim 3, wherein
the first parallax difference stored in the memory is a remainder obtained by dividing, by the number of parallaxes displayable on the display, a value obtained by multiplying a change in parallax due to one shift of a pixel by the number of pixels processed in parallel; and
the second parallax difference stored in the memory is a value obtained by subtracting the number of parallaxes from the first parallax difference.

5. The pixel processor of claim 3,
wherein the first coordinate difference stored in the memory is obtained by: multiplying a change in parallax due to one shift of a pixel by the predetermined number of pixels processed in parallel to obtain a first value; dividing the first value by the number of parallaxes displayable on the display to obtain a second value; truncating decimal places of the second value to obtain a third value; and multiplying the third value by a change in coordinate until the parallax is returned in accordance with shift of pixels in the display area, and
wherein the second coordinate difference stored in the memory is obtained by: multiplying the change in parallax due to one shift of a pixel by the predetermined number of pixels processed in parallel to obtain a fourth value; dividing the fourth value by the number of parallaxes displayable on the display to obtain a fifth value; adding one to the fifth value to obtain a sixth value; truncating decimal places of the sixth value to obtain a seventh value; and multiplying the seventh value by a change in coordinate until the parallax is returned in accordance with shift of pixels in the display area.

6. The pixel processor of claim 1, further comprising:
a first register configured to store therein a result of the addition by the first adder, between the first adder and the first selector; and
a second register configured to store therein a result of the addition by the second adder, between the second adder and the second selector.

7. A pixel processing method performed in a pixel processor comprising a storage module configured to store therein an initial parallax value, an initial coordinate value, a parallax difference, and a coordinate difference, wherein
the initial parallax value represents a parallax allocated to a predetermined pixel comprised in a display area of a display which is capable of displaying a plurality of pieces of parallax image information with parallaxes different from each other,
the initial coordinate value represents a coordinate of the parallax image information displayed in the predetermined pixel,
the parallax difference is for calculating, from a parallax value representing a parallax allocated to one pixel, a parallax value allocated to other pixel, and
the coordinate difference is for calculating, from a coordinate of parallax image information displayed in one pixel, a coordinate of parallax image information displayed in other pixel,
the pixel processing method comprising:
adding, by a first adder, the parallax difference to the initial parallax value to calculate a parallax value of other pixel different from the predetermined pixel, and thereafter repeating adding the parallax difference to the calculated parallax value to calculate a parallax value allocated to each pixel; and
adding, by a second adder, the coordinate difference to the initial coordinate value to calculate a coordinate of other pixel different from the predetermined pixel, and thereafter repeating adding the coordinate difference to the calculated coordinate to calculate a coordinate of the parallax image information allocated to each pixel.
